(19) United States
(12) Patent Application Publication
(10) Pub. No.: US 2008/0152983 A1
(43) Pub. Date: Jun. 26, 2008

(54) SOLID OXIDE FUEL CELL POWER GENERATOR

(75) Inventors: Michio Horiuchi, Nagano (JP); Shigeaki Suganuma, Nagano (JP); Jun Yoshiike, Nagano (JP); Fumimasa Katagiri, Nagano (JP); Yasue Tokutake, Nagano (JP)

Correspondence Address: DRINKER BIDDLE & REATH (DC), 1500 K STREET, N.W., SUITE 1100, WASHINGTON, DC, 20005-1209, US

(73) Assignee: Shinko Electric Industries Co., Ltd., Nagano (JP)

(21) Appl. No.: 11/963,453

(22) Filed: Dec. 21, 2007

(30) Foreign Application Priority Data
Dec. 25, 2006 (JP) 2006-348120

(51) Int. Cl. H01M 8/10

(52) U.S. Cl. 429/30

(57) ABSTRACT

A solid oxide fuel cell power generator according to the invention includes a plurality of solid oxide fuel cells C having a cathode electrode layer 2 and an anode electrode layer 3 formed on both sides of a solid electrolytic substrate 1, and the solid oxide fuel cells C are disposed in such a manner that the respective anode electrode layers 3 of the adjacent solid oxide fuel cells C are opposed to each other. A first electric conductor 4 having a gas permeability is interposed between the opposed anode electrode layers 3 in contact with the anode electrode layers 3. The first electric conductor 4 has a first extended portion 41 which is extended beyond each of the anode electrode layers 3, and serves as a collector of the anode electrode layer 3.

### BACKGROUND OF THE INVENTION

1. Field of the Invention

The present invention relates to a solid oxide fuel cell power generator, and more particularly to a solid oxide fuel cell power generator having a structure in which a solid oxide fuel cell including a solid electrolytic substrate having a cathode electrode layer and an anode electrode layer formed thereon is provided and a closure is not required.

2. Description of the Related Art

In recent years, various fuel cells of a power generating type have been developed, including a solid oxide fuel cell where a solid electrolyte is employed. As an example of the solid oxide fuel cell, a burned product constituted by stabilized zirconia having yttria (Y₂O₃) added thereto is used as a solid electrolytic layer of an oxygen ion conducting type. A cathode electrode layer is formed on one of surfaces of the solid electrolytic layer while an anode electrode layer is formed on an opposite surface thereto, and oxygen or an oxygen containing gas is supplied to the cathode electrode layer side, and furthermore, a fuel gas such as methane is supplied to the anode electrode layer.

In the solid oxide fuel cell, oxygen (O₂) supplied to the cathode electrode layer is changed into an oxygen ion (O²⁻) at a boundary between the cathode electrode layer and the solid electrolytic layer, and said oxygen ion is conducted to the anode electrode layer through the solid electrolytic layer. Further, said oxygen ion reacts to a fuel gas, such as methane (CH₄) gas, which is supplied to the anode electrode layer, resulting in that water (H₂O), carbon dioxide (CO₂), hydrogen (H₂) and carbon monoxide (CO) are generated. In the reaction, the oxygen ion discharges an electron. Therefore, an electric potential difference is made between the cathode electrode layer and the anode electrode layer. If a lead wire is connected between the cathode electrode layer and the anode electrode layer, the electron in the anode electrode layer flows into the cathode electrode layer through the lead wire, by which electric power is generated as the solid oxide fuel cell. A driving temperature of the solid oxide fuel cell is approximately 1000° C.

The power generator using the solid oxide fuel cell of this type, however, requires different separate chambers, namely an oxygen or oxygen containing gas supplying chamber, and a fuel gas supplying chamber, which are respectively provided on the cathode electrode layer side and the anode electrode layer side separately from each other. In addition, it is inevitable for those chambers to be exposed to an oxidizing atmosphere and a reducing atmosphere at a high temperature. For these reasons, it is said that such a power generator is difficult to improve its durability of the solid oxide fuel cell.

On the otherhand, a solid oxide fuel cell having the following type has been developed. That is, a cathode electrode layer and an anode electrode layer are provided on opposite surfaces of a solid electrolytic layer in the solid oxide fuel cell, and the solid oxide fuel cell is put in a fuel gas, for example, a mixed fuel gas mixing a methane gas and an oxygen gas to generate an electromotive force between the cathode electrode layer and the anode electrode layer. In the solid oxide fuel cell of this type, the principle mechanism for generating the electromotive force between the cathode electrode layer and the anode electrode layer is the same as that of the solid oxide fuel cell of the separating type chamber as already explained above. However, since the whole solid oxide fuel cell can be set into a substantially identical atmosphere, it is possible to obtain a single type chamber in which the mixed fuel gas is supplied. Thus, this type of the fuel cell makes it possible to enhance the durability of the solid oxide fuel cell.

However, as for the power generator using the solid oxide fuel cell of the single type chamber, its driving operation is eventually required to be carried out at a high temperature of approximately 1000° C. For this reason, there is a risk of an explosion of the mixed fuel gas. In order to avoid such a risk, an oxygen concentration shall be set to be lower than the boundary condition of its explosion. However, in this case, there is a problem in that a fuel, such as methane, is more likely to be carbonized so that a cell performance is deteriorated. Therefore, there has been further proposed a power generator using a solid oxide fuel cell having a single type chamber which can use a mixed fuel gas in an oxygen concentration capable of suppressing the progressive carbonization of the fuel and preventing the explosion of the mixed fuel gas simultaneously as disclosed in JP A 2003-92124 Publication.

In the power generator using the solid oxide fuel cell having the single type chamber, it is not necessary to strictly separate a fuel and air from each other as in a conventional power generator using a solid oxide fuel cell, however, a hermetic sealing structure must be employed. A plurality of plate-shaped solid oxide fuel cells are stacked and connected by using an interconnecting material having a heat resistance and a high electric conductivity to increase an electromotive force in such a manner that a driving operation can be carried out at a high temperature. For this reason, the solid oxide fuel cell power generator having the single type chamber using the plate-shaped solid oxide fuel cell becomes a large-scaled structure, which ends up being a problem of increased cost. Moreover, as for an operation of the solid oxide fuel cell power generator having the single type chamber, a temperature is controlled to gradually rise from a need of preventing a crack of the solid oxide fuel cell. In this regard, the start timing of an electromotive operation is prolonged, which might be practically inefficient.

Therefore, there has been proposed an open type solid oxide fuel cell power generator in which a solid oxide fuel cell does not need to be accommodated in a container having a sealing structure such as shown in JP(A) 2006-253090 Publication. The JP(A) 2006-253090 Publication has disclosed an open type solid oxide fuel cell power generator capable of carrying out a safe processing for an exhaust gas while preventing an explosion protection from being caused by an exhaust gas of the fuel cell, and furthermore, easily heating the vicinity of the solid oxide fuel cell to have a driving temperature of the fuel cell by the combustion of the exhaust gas.

JP(A) 2006-253090 Publication has proposed an open type solid oxide fuel cell power generator 10 comprising a container 11 which vertically disposes respective surfaces of a plurality of solid oxide fuel cells C and surrounds and accommodates the solid oxide fuel cell C, a mixed fuel gas supply apparatus 12 for supplying air and a fuel to the solid oxide fuel cell C from an upper side of the container 11, and a combustion apparatus 13 for heating the solid oxide fuel cell C by a heat which burns an exhaust gas discharged from a lower end of the solid oxide fuel cell C at a lower side of the container 11.

In the solid oxide fuel cell power generator 10 shown in FIG. 10, two solid oxide fuel cell groups C10 obtained by stacking a plurality of solid oxide fuel cells C are provided, and are electrically separated from each other through an electrical insulating intermediate layer 100. In each of the solid oxide fuel cell groups C10, a gas transmitting conductive layer 101 is inserted between the adjacent solid oxide fuel cells C. The respective solid oxide fuel cell groups C10 are wholly connected electrically in series. The two solid oxide fuel cell groups C10 are electrically connected in parallel so that an output capacitance can be increased. However, the connecting method has not been specifically described. Depending on uses, moreover, it is necessary to connect the respective solid oxide fuel cells C in parallel in order to increase an output current. However, JP(A) 2006-253090 Publication has not described a collecting method for connecting the respective solid oxide fuel cells C in parallel in the solid oxide fuel cell group C10.

In the solid oxide fuel cell power generator 10 described in JP(A) 2006-253090 Publication, it is possible to enhance a power generating density per volume by the stacking structure of the solid oxide fuel cell C. However, a higher output fuel cell power generator has been demanded and a further enhancement in the power generating density has been expected. Moreover, a further reduction in a manufacturing cost has also been desired in order to promote the spread of the fuel cell power generator.

### SUMMARY OF THE INVENTION

Therefore, it is an object of the invention to provide an open type solid oxide fuel cell power generator in which a collecting structure is simple, a manufacturing cost is low, a electrically parallel or serial connection can easily be carried out, and a power generating density is high.

In order to solve the problems, as the first aspect in this invention, there provided a solid oxide fuel cell power generator comprising a plurality of solid oxide fuel cells, each having a cathode electrode layer and an anode electrode layer formed on both sides of a solid electrolytic substrate thereof, wherein first one of said plurality of solid oxide fuel cells and second one of said plurality of solid oxide fuel cells, being stacked adjacently thereto, are disposed in such a manner that an anode electrode layer of said first one of said plurality of solid oxide fuel cells and another anode electrode layer of said second one of said plurality of solid oxide fuel cells are opposed to each other, wherein a first electric conductor, having a gas permeability and functioning as a collector, is interposed between said opposed anode electrode layers in contact thereto, said first electric conductor including a first extended portion which is extended beyond each of the anode electrode layers.

Further, as the second and third aspects in this invention, there provided the solid oxide fuel cell power generator as described in the firs aspect, wherein a cathode electrode layer of said second one of said plurality of solid oxide fuel cells and a cathode electrode layer of third one of said plurality of solid oxide fuel cells, being stacked adjacently thereto, are opposed to each other, wherein a second electric conductor having a gas permeability and functioning as a collector is interposed between the opposed cathode electrode layers in contact thereto, said second electric conductor including a second extended portion which is extended beyond each of the cathode electrode layers. Further, the first extended portion and the second extended portion are disposed to be laterally offset in opposite directions to each other. Still further, sets of the first extended portions or sets of the second extended portions are respectively connected by the first connector or the second connector.

Moreover, the first electric conductor and/or the second electric conductor are formed in a concavo-convex shape or corrugate shape.

In addition, a third electric conductor having a gas permeability is interposed between the first electric conductor and the anode electrode layer and between the second electric conductor and the cathode electrode layer, respectively.

Furthermore, the first electric conductor, the second electric conductor or the third electric conductor is formed by a metallic mesh or a porous body. Moreover, the metallic mesh disposed between the opposed anode electrode layers is formed of nickel or an alloy of the nickel and copper.

The fuel cell stack is also formed by stacking the solid oxide fuel cells which interpose the first electric conductor and the second electric conductor therebetween, and the fuel cell stack is interposed between a pair of support plates, and each of the support plates is a metal plate having a surface covered with inorganic oxide.

In addition, this invention also provides a solid oxide fuel power generating system which includes a plurality of sub-power generators based on the aforementioned solid oxide fuel power generator as this invention, and one of said plurality of sub-power generators and another one of said plurality of sub-power generators are electrically connected in parallel or in series via the first connectors and the second connectors, respectively. Moreover, said plurality of sub-power generators are electrically separated from each other by a plurality of support plates being interposed therebetween, where each of the support plates is a metal plate having a surface covered with inorganic oxide material.

As described above, according to the solid oxide fuel cell power generator in accordance with the invention, a collecting structure is electrically simple, a manufacturing cost is low, a parallel or serial connection can easily be carried out and a power generating density is high.

### BRIEF DESCRIPTION OF THE DRAWINGS

FIG. 1A is a typical longitudinal sectional view showing a first embodiment of a solid oxide fuel cell power generator according to the invention, and FIG. 1B is atypical cross-sectional view showing the power generator;

FIG. 2A is a top view showing a fuel cell unit to be incorporated in the solid oxide fuel cell power generator in FIG. 1, and FIG. 2B is a side view, a part of which is taken away;

FIG. 3A is a plan view showing the solid oxide fuel cell to be used in the fuel cell unit in FIG. 2, and FIG. 3B is an enlarged sectional view taken along an X-X line in A;

FIG. 4 is an exploded perspective view showing a main part in the fuel cell unit of FIG. 2;

FIG. 5A is a partial sectional view showing an electric conductor in the fuel cell unit of FIG. 2 and FIG. 5B is a view showing a variant of the electric conductor;

FIG. 6 is an enlarged sectional view taken along a Y-Y line in FIG. 2B;

FIG. 7 is a top view corresponding to FIG. 2A, illustrating a second embodiment of the solid oxide fuel cell power generator according to the invention;

FIG. 8 is a top view corresponding to FIG. 2A, illustrating a third embodiment of the solid oxide fuel cell power generator according to the invention;

FIG. 9 is a top view corresponding to FIG. 2A, illustrating a fourth embodiment of the solid oxide fuel cell power generator according to the invention, and

FIG. 10 is a typical view showing an example in which a solid oxide fuel cell in a solid oxide fuel cell power generator according to the prior art is stacked.

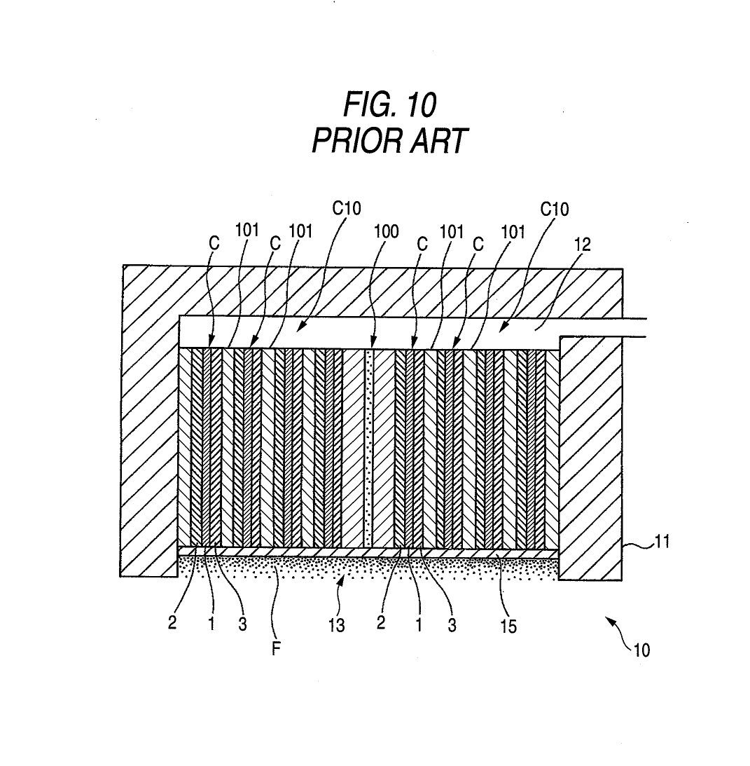

### DESCRIPTION OF THE PREFERRED EMBODIMENTS

Embodiments of the present invention will be described hereinbelow by reference to the drawings. Unless otherwise specifically defined in the specification, terms have their ordinary meaning as would be understood by those of ordinary skill in the art.

First to fourth preferred embodiments of a solid oxide fuel cell power generator according to the invention will be described below with reference to the drawings.

### First Embodiment

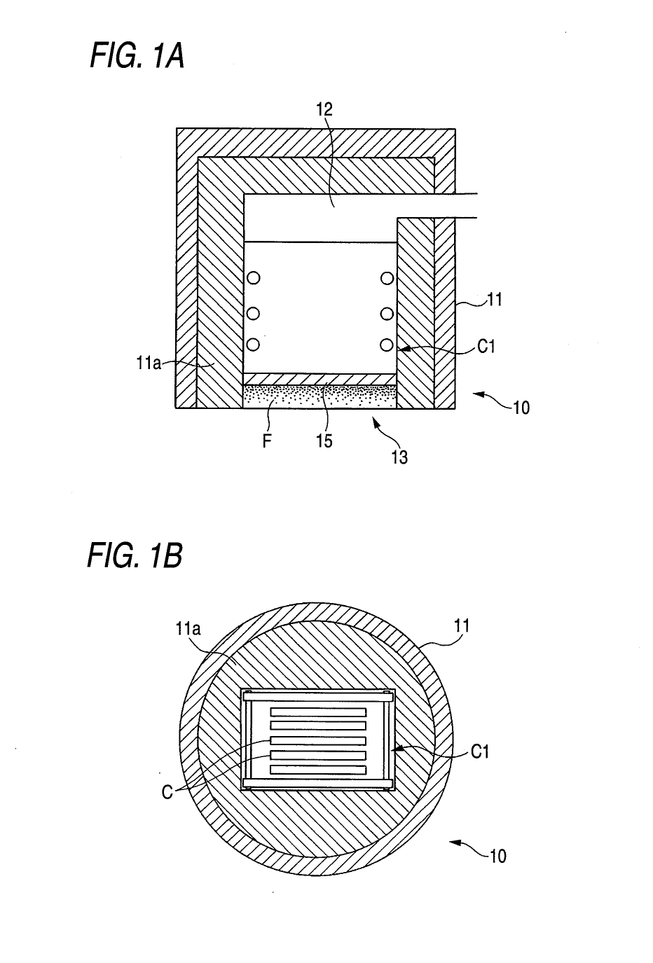

A solid oxide fuel cell power generator 10 according to the embodiment (which will be hereinafter referred to as the apparatus) comprises a plurality of solid oxide fuel cells C in which a cathode electrode layer 2 and an anode electrode layer 3 are formed on both sides of a solid electrolytic substrate 1 as shown in FIGS. 1 to 6.

In the apparatus 10, moreover, the solid oxide fuel cells C are disposed in such a manner that the respective anode electrode layers 3 of the adjacent solid oxide fuel cells C are opposed to each other. A first electric conductor 4 having a gas permeability is interposed between the opposed anode electrode layers 3 in contact with the respective anode electrode layers 3. The first electric conductor 4 has a first extended portion 41 which is extended beyond each of the anode electrode layers 3. The first electric conductor 4 serves as a collector of the anode electrode layer 3.

As shown in FIG. 1, the apparatus 10 comprises a fuel cell unit C1 formed by stacking a plurality of solid oxide fuel cells C, a heat insulating container 11 accommodating the fuel cell unit C1 therein, a mixed fuel gas supply apparatus 12 for supplying a mixed fuel gas of a fuel gas and an oxidant gas to the fuel cell unit C1, and a combustion apparatus 13 for burning the mixed fuel gas at a lower end of the container 11.

The apparatus 10 will further be described below. FIG. 1A typically shows a longitudinal section of the apparatus 10 and FIG. 1B typically shows a cross section of the apparatus 10.

The container 11 takes a circular shape having an opening portion on a lower side as shown in FIGS. 1A and 1B. An upper side of the container 11 is closed. A heat insulator 11a is filled around the fuel cell unit C1 accommodated in the container 11.

Thus, the apparatus 10 is an open type fuel cell power generator in which the fuel cell unit C1 having the solid oxide fuel cells C stacked thereon is accommodated in a so-called single type chamber.

The mixed fuel gas supply apparatus 12 is disposed above the fuel cell unit C1 in an upper part of the container 11. The mixed fuel gas is supplied from an upper end of the fuel cell unit C1 to each of the solid oxide fuel cells C by the mixed fuel gas supply apparatus 12. The mixed fuel gas which is not consumed by the fuel cell unit C1 passes through the fuel cell unit C1 and is discharged to a space formed on a lower end thereof. The mixed fuel gas is supplied from an outside of the container 11 to the mixed fuel gas supply apparatus 12 through a supply tube provided in a side part above the container 11.

The combustion apparatus 13 is disposed in the space formed on the lower end of the fuel cell unit C1. The mixed fuel gas discharged from the lower end of the fuel cell unit C1 is burned by the combustion apparatus 13 so that a flame F is generated in the space.

A plate-shaped electrical insulating porous body 15 having a gas permeability is disposed between the combustion apparatus 13 and the fuel cell unit C1. The electrical insulating porous body 15 is disposed with a direction of a place set to be almost orthogonal to a direction of a flow of the mixed fuel gas. The mixed fuel gas passes through the electrical insulating porous body 15 from the fuel cell unit C1 side to the combustion apparatus 13 side. The electrical insulating porous body 15 has the function of regulating the flow of the mixed fuel gas to generate a stable combustion.

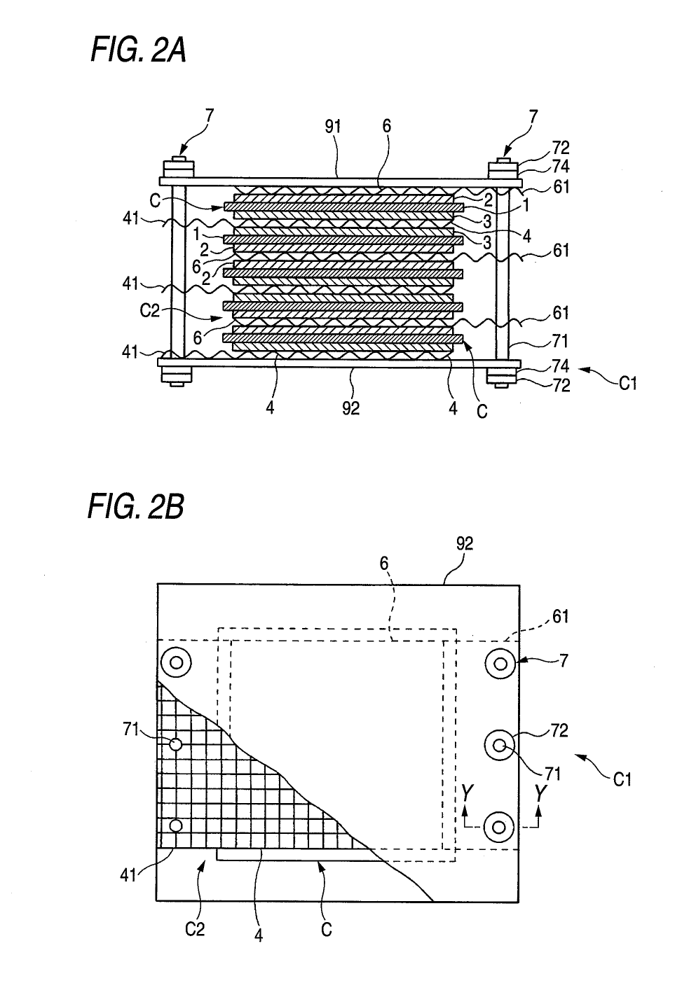

Next, the fuel cell unit C1 of the apparatus 10 will further be described below. FIG. 2A is a top view showing the fuel cell unit C1 seen from above and FIG. 2B is a side view showing the fuel cell unit C1, a part of which is taken away.

As shown in FIGS. 2A and 2B, the fuel cell unit C1 has a structure in which a fuel cell stack C2 formed by stacking a plurality of solid oxide fuel cells C interposing the first electric conductor 4 and a second electric conductor 6 which will be described below is provided between a pair of insulating support plates 91 and 92. Moreover, the fuel cell stack C2 and the pair of support plates 91 and 92 are fixed through a plurality of electrically conductive fixing means 7.

In the fuel cell stack C2, as shown in FIGS. 2A and 2B, a plurality of solid oxide fuel cells C are vertically stacked in a direction of thickness while its planar direction being aligned in a longitudinal direction of the container 11 with aligning their circumferential edges together. For this reason, vertical directions of the fuel cell stack C2 and the fuel cell unit C1 are coincident with a vertical direction of the container 11. Consequently, the mixed fuel gas can be easily supplied uniformly to each of the solid oxide fuel cells C and the heat can be readily transferred upward from the combustion apparatus 13. The details of the solid oxide fuel cell to be used in the invention will be described below.

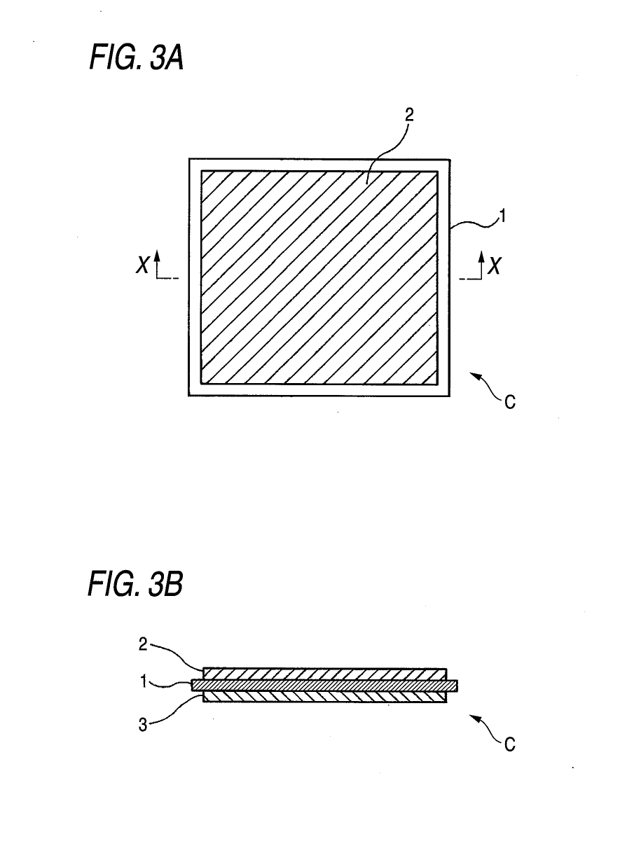

The mixed fuel gas supplied from the upper end of the fuel cell stack C2 passes toward the lower end of the fuel cell stack C2 along the plane of the solid oxide fuel cell C having a structure shown in FIGS. 3A and 3B.

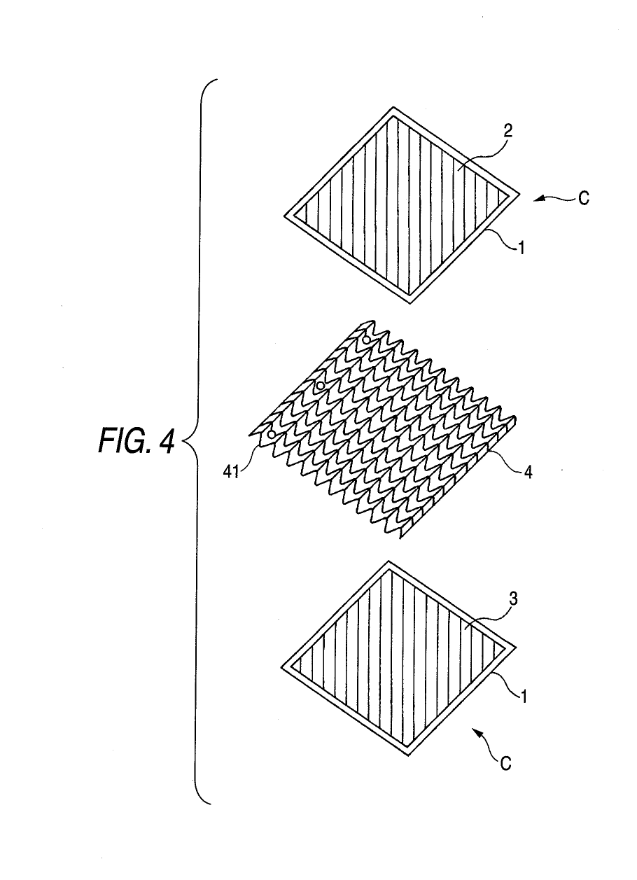

In the fuel cell stack C2, the solid oxide fuel cells C are stacked in such a manner that the respective anode electrodes 3 of the adjacent solid oxide fuel cells C are opposed to each other and the respective cathode electrode layers 2 of the adjacent solid oxide fuel cells C are opposed to each other. In the fuel cell stack C2, as shown in FIG. 4, the plate-shaped first electric conductor 4 having a gas permeability is interposed between the opposed anode electrode layers 3 in contact with the anode electrode layers 3. Similarly, the plate-shaped second electric conductor 6 having the air permeability is interposed between the opposed cathode electrode layers 2 in contact with the cathode electrode layers 2.

In the fuel cell stack C2, the number of the solid oxide fuel cells C to be stacked can be properly designed corresponding to an output characteristic depending on uses.

As shown in FIGS. 2A and 2B, the first electric conductor 4 has the first extended portion 41 which is extended beyond each of the anode electrode layers 3 on both sides interposing the first electric conductor 4 therebetween. Similarly, the second electric conductor 6 has a second extended portion 61 which is extended beyond each of the cathode electrode layers 2 on both sides interposing the second electric conductor 6 therebetween.

In the fuel cell stack C2 of the apparatus 10, the first electric conductor 4 and the second electric conductor 6 are also disposed on both sides of the stacked solid oxide fuel cell C respectively as shown in FIG. 2A. Thus, the fuel cell stack C2 has a structure in which each of the solid oxide fuel cells C is interposed between the first electric conductor 4 and the second electric conductor 6.

The first electric conductor 4 acts as a collector in contact with the anode electrode layer 3. Similarly, the second electric conductor 6 acts as a collector in contact with the cathode electrode layer 2. The first extended portion 41 and the second extended portion 61 are formed in positions which are shifted from each other in the planar directions of the first extended portion 41 and the second extended portion 61 as shown in FIG. 2B. In the apparatus 10, the first extended portion 41 and the second extended portion 61 are extended in an orthogonal direction (hereinafter referred to as a lateral direction) to a vertical direction of the fuel cell stack C2 (which will be hereinafter referred to as a vertical direction) in the positions shifted in opposite directions to each other.

In the apparatus 10, moreover, the first electric conductor 4 and the second electric conductor 6 have concavo-convex shapes as shown in FIG. 2A and FIG. 4, respectively. More specifically, the concavo-convex shape can also be replaced with a periodic wavy shape, for example.

Thus, the first electric conductor 4 and the second electric conductor 6 take the concavo-convex shapes, respectively. Therefore, an elasticity and a flexibility in the planar direction and a perpendicular direction thereto are enhanced and a force for moderately pressing the solid oxide fuel cell C in the planar direction is increased so that they come in contact with the planes of the anode electrode layer 3 and the cathode electrode layer 2 in the convex shapes, respectively.

Each of the first electric conductor 4 and the second electric conductor 6 has a wavy convex portion formed periodically like a ridge, and a groove-shaped concave portion is formed in parallel with the convex portion between the convex portions as shown in FIG. 4. It is preferable that a length obtained by measuring apexes of the respective convex and concave portions in a perpendicular direction to the plane of the first electric conductor 4 or the second electric conductor 6 should be 0.3 to 0.5 mm in respect of the maintenance and air permeability of the solid oxide fuel cell C in a state in which the fuel cell unit C1 is assembled.

Next, the first electric conductor 4 will further be described.

The first electric conductor 4 is provided in physical and electrical contact with the anode electrode layers 3 on both sides which interpose the first electric conductor 4 therebetween. It is preferable that the first electric conductor 4 should have the air permeability in the planar direction in respect of the supply of the mixed fuel gas to the anode electrode layers 3 on both sides. The air permeability in the planar direction implies that the first electric conductor 4 itself has the air permeability in the planar direction and the first electric conductor 4 has the air permeability in the planar direction by a clearance generated in an interposing state between the anode electrode layers 3 positioned on both sides.

Moreover, it is preferable that the first electric conductor 4 should have the air permeability in a perpendicular direction to the plane in order to enable a movement of the fuel gas between the pair of anode electrode layers 3 opposed to each other with the first electric conductor 4 interposed therebetween.

The reason will be described below.

In the case in which carbon hydride is used as the fuel gas, the fuel gas is modified so that a modified substance is generated and is consumed in the anode electrode layer 3. In the case in which a difference is made in a generating speed or a consuming speed of the modified substance in each of the anode electrode layers 3 opposed to each other with the first electric conductor 4 interposed therebetween, the movement of the fuel gas or the modified substance is enabled between the anode electrode layers 3 so that the fuel gas can be moved from a portion having a high fuel gas concentration to a portion having a low fuel gas concentration, and furthermore, the modified substance can be moved from a portion having a high modified substance concentration to a portion having a low modified substance concentration. As a result, it is possible to increase an electrical efficiency per volume of the solid oxide fuel cell C.

It is preferable that the first electric conductor 4 should have such a dimension as to cover the whole anode electrode layer 3 in respect of a collecting efficiency and a maintenance of the solid oxide fuel cell C. In the example shown in FIG. 2A, a dimension in the vertical direction of the first electric conductor 4 is equal to that of the anode electrode layer 3. The first electric conductor 4 has such a dimension in the lateral direction as to cover the whole anode electrode layer 3 in the lateral direction and to be extended toward one of sides in the lateral direction.

The description of the first electric conductor 4 is applied except that the second electric conductor 6 is not interposed between the anode electrode layers 3 but the cathode electrode layers 2. The reason why the second electric conductor 6 having the air permeability between the opposed cathode electrode layers 2 is preferable is that a movement of an oxidant gas is to be enabled.

It is preferable that materials for forming the first electric conductor 4 and the second electric conductor 6 should have such a rigidity or elasticity that the solid oxide fuel cell C can be maintained in the interposing state therebetween. Moreover, it is preferable that the materials should have a heat resistance and a durability in a temperature and an atmosphere which are used in the power generation of the solid oxide fuel cell C. Furthermore, it is preferable that the materials should have the air permeability.

From this viewpoint, it is preferable that the first electric conductor 4 and the second electric conductor 6 should be formed by a metallic mesh, a metal foam, a conductive porous body, a metallic plate taking a wavy shape, a metallic plate taking a wavy shape and having a large number of hole portions or a mesh made of carbon graphite.

As shown in FIG. 4, in the apparatus 10, the first electric conductor 4 and the second electric conductor 6 are formed by the metallic mesh in respect of a cost and a processability.

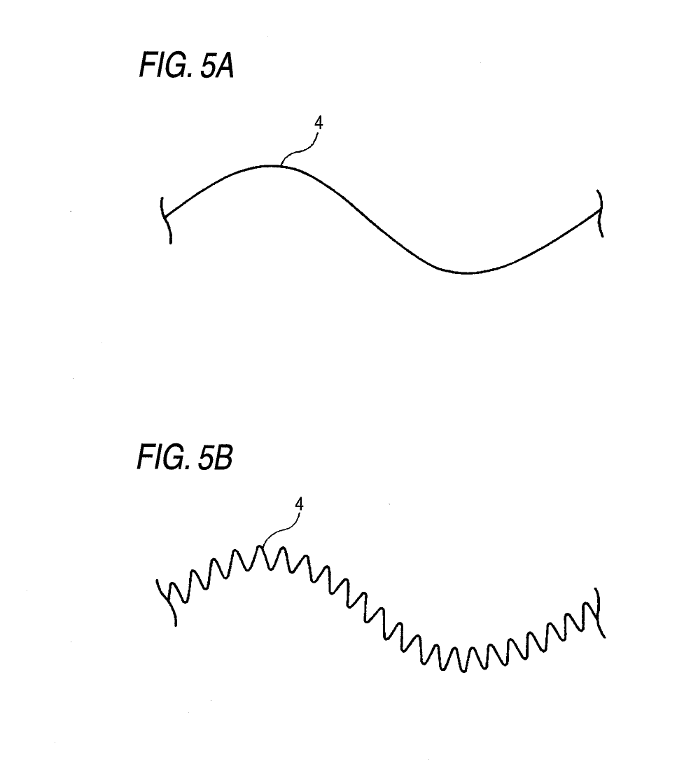

The first electric conductor 4 or the second electric conductor 6 which takes the periodic wavy shape in the apparatus 10 can be obtained by interposing the metallic mesh between a pair of dies having wavy pressing sections shown in FIGS. 4 and 5A and pressing and molding them, for example.

Moreover, FIG. 5B shows a variant of the metallic mesh. As in the variant, smaller concavo-convex portions may be formed on the first electric conductor 4 or the second electric conductor 6. In the variant, a waveform having a shorter cycle than the cycle of a basic waveform is superposed on the wavy shape shown in FIG. 5A.

In the variant, since the first electric conductor 4 or the second electric conductor 6 has the small concavo-convex portions, a flexibility thereof is increased. In addition, even if the surface of the anode electrode layer 3 or the cathode electrode layer 2 is not flat at all, physical and electrical contact points with both of the electrode layers are increased. Therefore, the maintenance of the solid oxide fuel cell C and an electrical contact state with both of the electrode layers are further enhanced.

The first electric conductor 4 shown in FIG. 5B or the second electric conductor 6 can be obtained by interposing the metallic mesh between a pair of dies having wavy pressing sections in a shorter cycle than that of a pair of dies having the wavy pressing sections shown in FIGS. 4 and 5A and pressing and molding them, and then pressing and molding them by the pair of dies having the wavy pressing sections shown in FIGS. 4 and 5A, for example.

Although the first electric conductor 4 or the second electric conductor 6 has the concavo-convex portions taking the periodic wavy shape, it may have dimple-like concavo-convex portions which are formed regularly or randomly.

Preferably, a mesh in the metallic mesh has such a dimension that the solid oxide fuel cell C to be interposed can be fixed and the fuel gas and the oxidant gas which are contained in the mixed fuel gas can easily pass therethrough.

More specifically, it is preferable that a metal wire constituting the mesh in the metallic mesh should have a diameter of 30 to 150 μm and the number of meshes should be 60 to 500. In particular, it is preferable that the wire diameter should be 70 to 130 μm and the number of the meshes should be 70 to 130 in respect of the maintenance, collecting efficiency and processability of the solid oxide fuel cell C. In the apparatus 10, a metallic mesh having a wire diameter of 100 μm and 100 meshes is used.

For a material for forming the metallic mesh, moreover, nickel, a nickel alloy, stainless steel or a heat-resistant and corrosion-resistant alloy is preferable. For the stainless steel, SUS310 or SUS430 is preferable.

In the case in which a carbon hydride fuel gas having a C-H bond is used as the fuel gas, particularly, it is preferable that the metallic mesh disposed between the anode electrode layers 3 of the solid oxide fuel cell C should be formed by the nickel or the nickel alloy in order to act as a catalyst for cutting the C-H bond of a fuel molecule. In the case in which the metallic mesh is formed by the nickel alloy, particularly, it is preferable that the alloy should be formed of nickel and copper in respect of the non-promotion of the generation of a soot due to the nickel.

In the case in which the metallic mesh is formed by the nickel alloy, it is preferable that a ratio of the nickel to the alloy should be equal to or higher than 60% by mass and be lower than 100% by mass, and particularly, should be equal to or higher than 80% by mass and be lower than 100% by mass in order to have a catalytic action and to prevent the generation of the soot from being promoted. Moreover, it is preferable that the nickel in the alloy should be present on a surface thereof. Also in the case in which the first electric conductor 4 or the second electric conductor 6 is formed by the conductive porous body or the metallic plate, the foregoing is applied in the same manner.

Next, the pair of support members 91 and 92 for forming the fuel cell unit C1 will further be described.

In the apparatus 10, the fuel cell stack C2 is interposed and fixed between the insulating support plates 91 and 92 disposed on both sides thereof as shown in FIGS. 2A and 2B. It is preferable that the dimensions of the respective support plates 91 and 92 should be greater than the dimension of the solid oxide fuel cell C in order to enhance the maintenance of the fuel cell stack C2. In the apparatus 10, each of the support plates 91 and 92 takes a square shape and has a greater dimension than that of the solid oxide fuel cell C as shown in FIG. 2B. The fuel cell stack C2 is interposed in an inner part from edges of the support plates 91 and 92.

It is preferable that a material for forming the respective support plates 91 and 92 should have a rigidity capable of maintaining a state in which the fuel cell stack C2 is interposed. Moreover, it is preferable that the material should have an electrical insulating property, a heat resistance and a durability in a temperature and an atmosphere which are used in the power generation of the fuel cell stack C2.

More specifically, it is preferable that each of the respective support plates 91 and 92 should be formed by a metal plate having a surface covered with inorganic oxide. For the inorganic oxide, ceramics or an inorganic oxide sheet having a flexibility is preferable, for example. Examples of the ceramics include alumin a based ceramics, mullite based ceramics, cordierite based ceramics and forsrite based ceramics. Moreover, it is preferable that the inorganic oxide sheet having the flexibility should be a cloth or a nonwoven fabric which is formed of a fiber made of quartz, glass, alumina based ceramics, for example. It is preferable that the inorganic oxide covering the metal plate should be formed by the inorganic oxide sheet having the flexibility in order to enhance a shock resistance.

In the apparatus 10, moreover, each of the support plates 91 and 92 may be formed by spraying the ceramics onto the surface of the metal plate. The metal plate has a higher thermal conductivity than that of the solid oxide fuel cell C formed of the ceramics. Therefore, the thermal conductivity of the support plate is higher than that of the solid oxide fuel cell C. By employing the support plate having the structure, it is possible to shorten a time required for driving the fuel cell unit C1 as will be described below.

Next, the solid oxide fuel cell C to be suitably used in the fuel cell unit C1 will be described below with reference to FIGS. 3A and 3B.

The solid oxide fuel cell C has the plate-shaped solid electrolytic substrate 1, and the cathode electrode layer 2 is formed like a plate on one of the surfaces of the substrate 1 and the anode electrode layer 3 is formed like a plate on the other surface thereof. The solid oxide fuel cell C is wholly plate-shaped.

The shape of the solid oxide fuel cell C seen on a plane can be optional depending on uses. In respect of a stacked arrangement of the solid oxide fuel cells C in a predetermined space and a processability, all of the solid electrolytic substrate 1, the cathode electrode layer 2 and the anode electrode layer 3 take square shapes in the apparatus 10. Moreover, the cathode electrode layer 2 and the anode electrode layer 3 are formed in equal dimensions and are slightly smaller than the solid electrolytic substrate 1.

In the example shown in FIGS. 2A and 2B, moreover, the fuel cell stack C2 is fixed with a plurality of conductive fixing means 7 together with the support plates 91 and 92 through the first electric conductor 4 and the second electric conductor 6 in the fuel cell unit C1. In the apparatus 10, three fixing means 7 are provided on each of left and right sides so that six fixing means 7 are used in total. The fixing means 7 is constituted by a bolt 71 and a nut 72.

In the apparatus 10, as shown in FIG. 2B, three holes are formed at a predetermined interval in a vertical direction on each of an end in the lateral direction of the first extended portion 41 in the first electric conductor 4, an end in the lateral direction of the second extended portion 61 of the second electric conductor 6 and both ends in the lateral direction of the support plates 91 and 92. A pair of nuts 72 is screwed into both ends of the bolt 71 in a state in which the bolt 71 is inserted through each of the holes, and the fuel cell stack C2 and the support members 91 and 92 are thus pressed and fixed. Moreover, an insulating washer 74 is disposed between each of the support members 91 and 92 and the nut 72.

In the apparatus 10, a force is generated against a pressing force of the fixing means 7 by the elasticity of the first electric conductor 4 and the second electric conductor 6which are interposed between the solid oxide fuel cells C in the fuel cell stack C2 so that a state in which the fuel cell stack C2 is interposed between the support members 91 and 92 is maintained reliably.

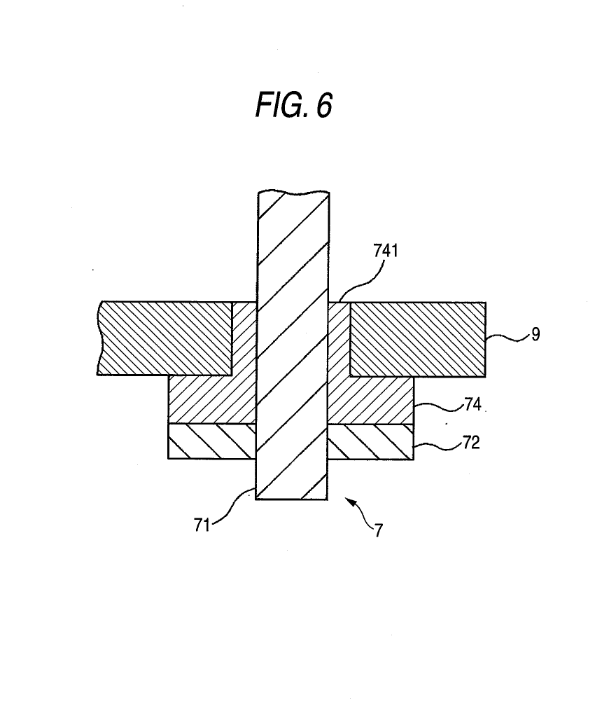

It is preferable that at least one of the support plates 91 and 92 and the fixing means 7 should be insulated from each other in order to prevent an electrical short circuit. In the apparatus 10, the support plates 91 and 92 and the fixing means 7 are electrically insulated from each other through the washer 74. In the apparatus 10, as shown in FIG. 6, the insulating washer 74 is provided with a cylindrical vertical portion 741 which is extended toward the support member 91 and 92 sides, and the vertical portion 741 is fitted in the holes of the support plates 91 and 92 and the bolt 71 is inserted through the vertical portion 741.

In the apparatus 10, as described above, the metal plate is disposed in each of the support plates 91 and 92. Therefore, it is necessary to have the insulating structure. In the case in which each of the support plates 91 and 92 does not include an electric conductor such as the metal plate, however, it is not necessary to have the insulating structure.

The fixing means 7 will further be described. The fixing means 7 serves as a portion for deriving a power from the fuel cell stack C2. The bolt 71 inserted through each of the first extended portions 41 is brought into a state in which it comes in electrical contact with the first extended portion 41. Therefore, the respective anode electrode layers 3 are electrically connected in parallel.

In order to reliably set the electrical contact state, the hole part of the first extended portion 41 through which the bolt 71 is inserted may be fixed to the bolt 71 by using the nut 72 at both sides. An electrical contact state of the second extended portion 61 and the bolt 71 is the same as that in the first extended portion 41.

In the apparatus 10, thus, the first extended portions 41 and the second extended portions 61 are fixed to the bolt 71 and are electrically connected to each other. In the fuel cell unit C1, the respective solid oxide fuel cells C are electrically connected in parallel.

In the apparatus 10, the fuel cell unit C1 having the structure is accommodated in the container 11 as shown in FIGS. 1A and 1B.

In another embodiment, as will be described below, it is possible to easily implement an electrical parallel or serial connection by connecting the fuel cell units Cl or the fuel cell stacks C2 as a unit in the solid oxide fuel cell power generator 10 according to the invention.

Next, a material for forming the solid oxide fuel cell C will be described below.

A well-known substrate can be employed for the solid electrolytic substrate 1, for example, and the following materials can be used:
a) YSZ (yttria-stabilized zirconia), ScSZ (scandia-stabilized zirconia), and zirconia based ceramics obtained by doping them with Ce or Al;
b) Ceria based ceramics such as SDC (samaria doped ceria) or SGC (gadolia doped ceria); and
c) LSGM (lanthanum gallate), bismuth oxide based ceramics.

In this specification, thus, the solid oxide includes a solid electrolyte.

Moreover, the anode electrode layer 3 is formed by a porous body and a well-known material can be employed for a forming material thereof, for example, and the following materials can be used:

d) cermet of nickel and yttria-stabilized zirconia based, scandia-stabilized zirconia based or ceria based (SDC, GDC or YDC) ceramic;

e) a sintered body containing conductive oxide as a main component (50% by mass or more and 99% by mass or less). The conductive oxide is nickel oxide in which lithium is dissolved, for example; and

f) a substance obtained by blending the substances in the d) and e) with a metal constituted by a platinum group element or rhenium or oxide thereof in approximately 1 to 10% by mass.

In particular, the materials in the d) and e) are preferable.

The sintered product containing the conductive oxide in the (e) as a main component has an excellent oxidation resistance and can thus prevent a phenomenon, for example, a reduction in an electrical efficiency caused by a rise in an electrode resistance of the anode electrode layer which is generated by an oxidation of the anode electrode layer, a power generating impossibility or a separation of the anode electrode layer from the solid oxide layer. Moreover, nickel oxide having lithium dissolved therein is suitable for the conductive oxide. Furthermore, it is possible to obtain a high power generating performance by blending the materials in the d) and e) with the metal formed of the platinum group element or the rhenium or the oxide thereof.

The cathode electrode layer 2 is formed by a porous body and a well-known material can be employed for the forming material. For example, it is possible to employ manganese to be the third group element in a periodic table, for example, lanthanum or samarium having strontium (Sr) added thereto (for example, lanthanum strontium manganite), a gallium or cobalt acid compound (for example, lanthanum strontium cobaltite or samarium strontium cobaltite).

Both the anode electrode layer 3 and the cathode electrode layer 2 are formed by porous bodies, and the solid electrolytic substrate 1 in the apparatus 10 may be formed to be porous. Conventionally, a solid electrolytic layer constituting a substrate is formed to be dense. However, a thermal shock resistance is low and a crack is easily generated by a rapid change in a temperature. In general, the solid electrolytic layer is formed more thickly than the anode electrode layer and the cathode electrode layer. Therefore, the crack is generated over the whole solid oxide fuel cell to be broken into pieces due to the crack of the solid electrolytic layer.

Also in the apparatus 10, the individual solid electrolytic substrates are formed to be porous. Therefore, the crack can further be suppressed and the thermal shock resistance can be enhanced more greatly even if they are disposed in a flame or in the vicinity of the flame in the power generation and a change in a temperature is rapidly given, and furthermore, in a heat cycle having a considerable temperature difference. Also in the case in which the solid electrolytic substrate is porous, a remarkable enhancement in the thermal shock resistance is not observed when a porosity is lower than 10%. If the porosity is equal to or higher than 10%, however, an excellent thermal shock resistance is observed. A porosity of 20% or higher is more suitable.

For the solid oxide fuel cell which has been proposed previously, a mesh-like metal or a wire-shaped metal is buried in the anode electrode layer or the cathode electrode layer or is fixed thereto. This is a countermeasure for carrying out a reinforcement to prevent the solid electrolytic substrate having a crack due to a thermal history from being broken into pieces. According to the countermeasure, also after the solid electrolytic substrate is cracked into pieces, the cracked portions maintain a power generating performance. Therefore, the mesh-like metal or the wire-shaped metal electrically connect the cracked portions and can derive a power as one solid oxide fuel cell.

In the invention, however, there is employed a structure in which the mesh-like metal or the wire-shaped metal is neither buried in the anode electrode layer or the cathode electrode layer nor fixed there to but the solid oxide fuel cell C is interposed between the first electric conductor 4 and the second electric conductor 6 which are disposed in contact with the anode electrode layer 3 and the cathode electrode layer 2, respectively. Even if the solid electrolytic substrate 1 is cracked into pieces, therefore, the cracked portions are held between the first electric conductor 4 and the second electric conductor 6 while maintaining the power generating performance. Therefore, the first electric conductor 4 and the second electric conductor 6 electrically connect the cracked portions and can thus drive a power as the solid oxide fuel cell.

Accordingly, the manufacture of the solid oxide fuel cell C employed in the invention can be more simplified and a cost can be reduced more greatly than the process for manufacturing the solid oxide fuel cell proposed previously.

The apparatus 10 can generate a power in the following manner, for example.

First of all, when the fuel cell unit C1 is to be driven, the mixed fuel gas is supplied from the mixed fuel supply apparatus 12 to the upper end of the fuel cell unit C1, and the mixed fuel gas discharged from the lower end of the fuel cell unit C1 is burned by the combustion apparatus 13 to generate the flame F. By the flame F, the fuel cell unit C1 is heated to a temperate at which a power generation driving operation can be carried out.

In this case, the support plates 91 and 92 include the metal plates in the fuel cell unit C1. Therefore, the fuel cell unit Cl has a higher thermal conductivity than the solid oxide fuel cell C. For this reason, the fuel cell unit C1 is heated up more quickly than the solid oxide fuel cell C when the heating is carried out by the flame. As a result, both sides of the fuel cell unit C1 are also heated quickly from the lower end to the upper end by the support plates 91 and 92 which are heated up. In the apparatus 10, therefore, a time required for driving the fuel cell unit C1 is short.

After the start of the power generation of the fuel cell unit C1, the mixed fuel gas which has not been completely consumed by the fuel cell unit C1 is discharged from the lower end of the fuel cell unit C1. Therefore, the mixed fuel gas thus discharged is safely subjected to a burning treatment by the combustion apparatus 12, and furthermore, the fuel cell unit C1 is maintained at the driving temperature.

According to the apparatus 10, the collecting structure is simple. Therefore, the manufacturing cost can be reduced. Moreover, it is possible to easily carry out the parallel or serial connection by setting the fuel cell unit C1 or the fuel cell stack C2 as a unit and to properly design an output voltage or an output current depending on uses.

In the apparatus 10, furthermore, the anode electrode layers 3 and the cathode electrode layers 2 in the adjacent solid oxide fuel cells C are disposed opposite to each other with the electric conductors having the air permeability provided therebetween. Consequently, a power generating density per volume is increased.

In addition, the apparatus 10 has an open type structure and does not require a sealing structure. Therefore, a simple structure can be obtained.

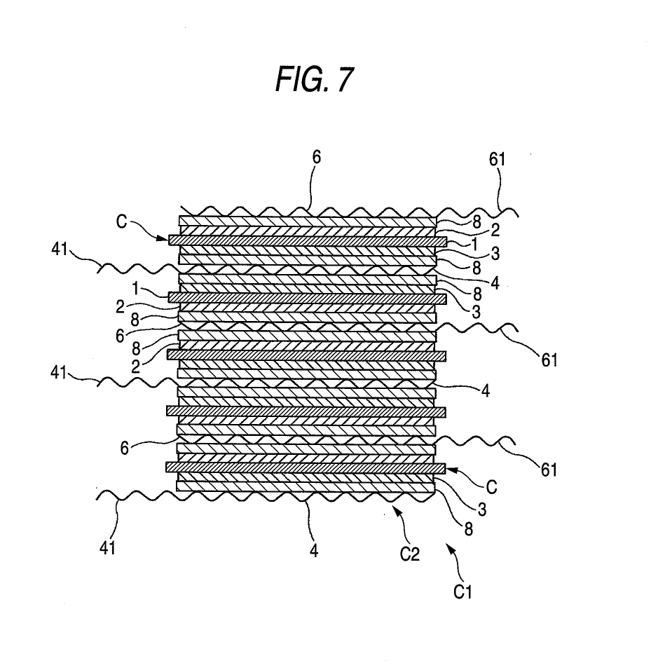

Next, a solid oxide fuel cell power generator according to another embodiment of the invention will be described below with reference to FIGS. 7 to 9. In another embodiment, the detailed description of the embodiment is properly applied to common portions to the first embodiment. In FIGS. 7 to 9, moreover, the same members as those in FIGS. 1 to 6 have the same reference numerals.

### Second Embodiment

A solid oxide fuel cell power generator 10 according to a second preferred embodiment of the invention is shown in FIG. 7. As shown in an example of FIG. 7, a plate-shaped third electric conductor 8 having a gas permeability is interposed between a first electric conductor 4 and an anode electrode 3 positioned on both sides thereof in the apparatus 10. Similarly, the plate-shaped third electric conductor 8 having the air permeability is interposed between a second electric conductor 6 and a cathode electrode layer 2 positioned on both sides thereof. In a fuel cell stack C2 of the apparatus 10, the third electric conductor 8 is interposed between the first electric conductor 4 and the anode electrode layer 3 and between the second electric conductor 6 and the cathode electrode layer 2 at both sides of a solid oxide fuel cell C which is stacked, respectively.

In FIG. 7, for easy understanding of the structure of the apparatus 10, a pair of support plates and fixing means are not shown.

The third electric conductor 8 is plate-shaped and takes a square shape seen on a plane, and has a dimension which is equal to the dimensions of both of the electrode layers 2 and 3 in the solid oxide fuel cell C. Thus, the eighth electric conductor 8 has a large contact area with the anode electrode layer 3 and the cathode electrode layer 2, and an electrical contact state with each of the electrode layers is excellent.

The other structures are the same as those in the first embodiment.

The anode electrode layer 3 and the cathode electrode layer 2 in the solid oxide fuel cell C and the plate-shaped third electric conductor 3 come in face contact with each other. Therefore, an electron conductivity from the electrode layers 2 and 3 to the third electric conductor 8 is high. On the other hand, the first electric conductor 4 or the second electric conductor 6 which has a concavo-convex shape mainly comes in point contact or line contact with the third electric conductor 8, and both of them are formed by the electric conductor. Therefore, the electron conductivity between both of them is sufficiently ensured.

In the apparatus 10, accordingly, a collecting efficiency from the anode electrode layer 3 and the cathode electrode layer 2 to the first electric conductor 4 or the second electric conductor 6 is enhanced.

From this viewpoint, in the case in which the third electric conductor 8 is formed by a metallic mesh, it is preferable to employ the mesh having a smaller dimension than the dimensions of the first electric conductor 4 and the second electric conductor 6 in order to increase the number of electrical contact points.

In the apparatus 10, the third electric conductor 8 also has a gas permeability in a planar direction and a perpendicular direction to the plane in the same manner as the first electric conductor 4 or the second electric conductor 6.

As a material for forming the third electric conductor 8, it is possible to use the same material as the first electric conductor 4 or the second electric conductor 6. Moreover, a metallic wool such as a steel wool may be used. In the apparatus 10, the third electric conductor 8 is formed by a plate-shaped metallic mesh in the same manner as the first electric conductor 4 and the second electric conductor 6.

In the case in which carbon hydride is used for the fuel gas, it is preferable that the metallic mesh disposed adjacently to the anode electrode layer 3 should be formed by nickel or a nickel alloy in order to act as a catalyst for cutting the C-H bond of a fuel molecule as described above.

According to the apparatus 10, the collecting efficiency from each of the electrode layers 2 and 3 can be enhanced.

### Third Embodiment

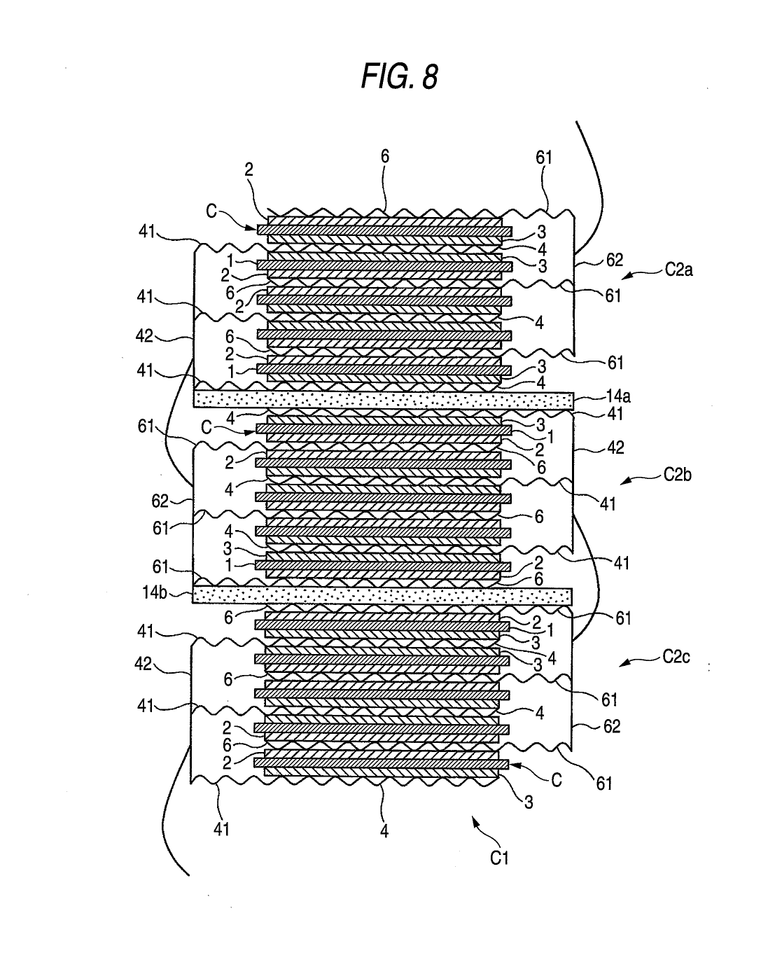

A solid oxide fuel cell power generation system employing the solid oxide fuel cell power generator 10 according to a third preferred embodiment of the invention is shown in FIG. 8. FIG. 8is a top view showing three fuel cell stacks. In the embodiment, there are provided three fuel cell stacks C2a, C2b and C2c as shown in an example of FIG. 8. A plurality of first extended portions 41 and a plurality of second extended portions 61 have a first connector 42 and a second connector 62, respectively. The first extended portions 41 are electrically connected to each other through the first connector 42. Similarly, the second extended portions 61 are electrically connected to each other through the second connector 62.

The three fuel cell stacks C2a, C2b and C2c are disposed. The three fuel cell stacks C2a, C2b and C2c are electrically connected in series through the first connectors 42 and the second connectors 62 therein.

Each of the three fuel cell stacks C2a, C2b and C2c has a structure in which a plurality of solid oxide fuel cells C is stacked in the same manner as in the first embodiment. Each of the solid oxide fuel cells C is interposed between a first electric conductor 4 and a second electric conductor 6.

The respective solid oxide fuel cells C constituting the three fuel cell stacks C2a, C2b and C2c have a planar direction aligned with a vertical direction of a container 11 and contours taking external shapes arranged, and are wholly stacked in a perpendicular direction as shown in FIG. 8.

In a stacking direction of the solid oxide fuel cell C (which will be hereinafter referred to as a stacking direction), the fuel cell stack C2b is interposed between the fuel cell stack C2a and the fuel cell stack C2c. The fuel cell stack C2a and the fuel cell stack C2b are disposed in a state in which the anode electrode layers 3 positioned on ends in the stacking direction are opposed to each other. Moreover, the fuel cell stack C2b and the fuel cell stack C2c are disposed in a state in which the cathode electrode layers 2 positioned on ends in the stacking direction are opposed to each other.

Each of the first extended portions 41 in the fuel cell stack C2b is extended in an opposite direction to the fuel cell stacks C2a and C2c. Moreover, each of the second extended portions 61 in the fuel cell stack C2b is extended in an opposite direction to the fuel cell stacks C2a and C2c.

A pair of support plates 91 and 92 are disposed on outer parts in the stacking direction in the fuel cell stack C2a and the fuel cell stack C2c in the same manner as in the first embodiment, and interpose the three fuel cell stacks C2a, C2b and C2c therebetween to constitute a fuel cell unit C1, which is not shown in FIG. 8. Moreover, the three fuel cell stacks C2a, C2b and C2c and the pair of support plates 91 and 92 are fixed by a plurality of fixing means 7 (not shown) to constitute the fuel cell unit C1 in the same manner as in the first embodiment.

The fuel cell unit C1 is accommodated in the container 11 (not shown) in the same manner as in the first embodiment.

Although the first extended portions 41 and the second extended portions 61 are fixed by the fixing means 7 respectively in the same manner as in the first embodiment, the fixing means 7 and the first extended portion 41 or the second extended portion 61 are electrically insulated from each other. As the insulating method, various well-known methods can be used. In the apparatus 10, the same method as the washer 74 shown in FIG. 6 is used. More specifically, a washer including a cylindrically vertical portion is fitted in a hole of the first extended portion 41 or the second extended portion 61 through which a bolt 71 is inserted, and the bolt 71 is inserted through the vertical portion.

As shown in FIG. 8, the first connector 42 of the fuel cell stack C2a and the second connector 62 of the fuel cell stack C2b are connected to each other through a wiring. Moreover, the first connector 42 of the fuel cell stack C2b and the second connector 62 of the fuel cell stack C2c are connected to each other through a wiring. Thus, the three fuel cell stacks C2a, C2b and C2c are electrically connected in series.

A power deriving portion of the apparatus 10 is formed by the second connector 62 which is connected in the fuel cell stack C2a and the first connector 42 which is connected in the fuel cell stack C2c.

In the apparatus 10, moreover, an insulating separator 14a having a gas permeability is interposed between the anode electrode layers 3 which are opposed to each other in the fuel cell stack C2a and the fuel cell stack C2b respectively as shown in FIG. 8. By the separator 14a, the fuel cell stack C2a and the fuel cell stack C2b are electrically insulated from each other. Similarly, an insulating separator 14b having a gas permeability is interposed between the cathode electrode layers 2 which are opposed to each other in the fuel cell stack C2b and the fuel cell stack C2c respectively. By the separator 14b, the fuel cell stack C2b and the fuel cell stack C2c are electrically insulated from each other.

The separators 14a and 14b have the air permeability in a planar direction of the solid oxide fuel cell C and a perpendicular direction to the plane in the same manner as the first electric conductor 4 or the second electric conductor 6.

It is preferable that dimensions in the planar direction of the separators 14a and 14b should be greater than the electrode layers 2 and 3 and be equal to or greater than the first electric conductor 4 and the second electric conductor 6 in order to electrically insulate the fuel cell units. In the apparatus 10, the dimensions of the separators 14a and 14b are equal to the first electric conductor 4 and the second electric conductor 6.

The separators 14a and 14b are also fixed to a plurality of bolts 71 and are stacked in the fuel cell unit C1.

It is preferable that materials for forming the separators 14a and 14b should have an electrical insulating property, a heat resistance and a durability in a temperature and an atmosphere which are used in the power generation of the solid oxide fuel cell C. From this viewpoint, it is preferable that the separators 14a and 14b should be formed by a porous body of inorganic oxide. It is preferable that pores of the porous body should communicate with each other.

In the case in which a fuel of carbon hydride having a C—H bond is used as the fuel gas, it is preferable that atoms or particles of a metal having a catalytic action for cutting the C—H bond, for example, platinum, rhodium or nickel should be distributed and disposed on a surface of the pore of the porous body in the separator 14a interposed between the anode electrode layers 3.

The C—H bond is cut by the atoms or particles of the metal so that the carbon hydride molecule entering the pore of the separator 14a is promoted to be modified into a modified substance.

It is possible to manufacture the separator 14a by impregnating the porous body constituted by the inorganic oxide with a solution such as hexafluoroplatinate and then heat treating the porous body, thermally decomposing the hexafluoroplatinate to deposit a metal such as platinum on the surface of the pore, for example.

According to the apparatus 10, the three fuel cell stacks C2a, C2b and C2c are electrically connected in series through a simple wiring. Moreover, the separator 14a having a modifying function is disposed between the anode electrode layers 3 which are opposed to each other in the fuel cell stack C2a and the fuel cell stack C2b so that an electrical efficiency can be increased.

While the apparatus 10 is constituted by the three fuel cell stacks C2a, C2b and C2c in the embodiment, moreover, it is possible to prepare an optional number of fuel cell stacks and to easily connect them in series in order to obtain a necessary output voltage depending on uses. Furthermore, a plurality of fuel cell stacks having the structure maybe prepared and connected in parallel.

### Fourth Embodiment

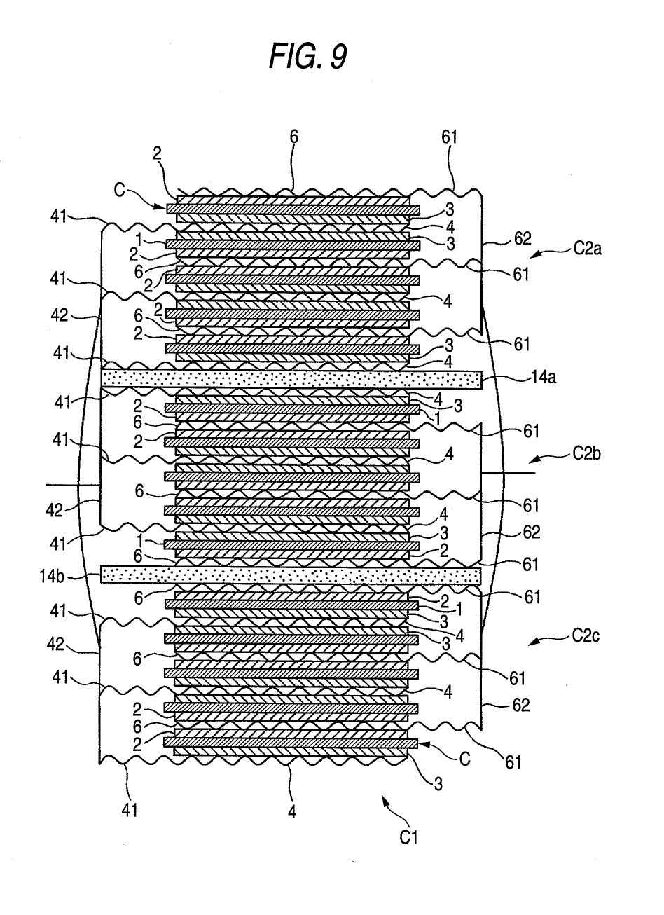

A solid oxide fuel cell power generating system employing the solid oxide fuel cell power generator 10 according to a fourth preferred embodiment of the invention is shown in FIG. 9. FIG. 9 is a top view showing three fuel cell stacks. The apparatus 10 comprises three fuel cell stacks C2a, C2b and C2c. The three fuel cell stacks C2a, C2b and C2c are disposed. The three fuel cell stacks C2a, C2b and C2c are electrically connected in parallel by a first connector 42 and a second connector 62 in the fuel cell stacks C2a, C2b and C2c, respectively.

The other structures are the same as those in the third embodiment.

In the three fuel cell stacks C2a, C2b and C2c, the first connectors 42 are electrically connected to each other through a wiring. Similarly, the second connectors 62 are electrically connected to each other through a wiring.

Although first extended portions 41 and second extended portions 61 in the fuel cell stacks C2a, C2b and C2c are connected to each other through the first connector 42 and the second connector 62 in FIG. 9, they may be connected by using a bolt and a nut of fixing means. In this case, an insulating washer does not need to be used but the first extended portions 41 and the second extended portions 61 are fixed with an electrically conductive volt and are also connected electrically.

According to the apparatus 10, the three fuel cell stacks C2a, C2b and C2c are connected in parallel through a simple wiring.

While the apparatus 10 is constituted by the three fuel cell stacks C2a, C2b and C2c in the embodiment, moreover, it is possible to prepare a plurality of fuel cell stacks, thereby connecting them easily in parallel in order to obtain a necessary output current depending on uses.

The solid oxide fuel cell power generator according to the invention is not restricted to the embodiments but it can be properly changed without departing from the scope of the invention.

Although the first extended portions 41 or the second extended portions 61 are electrically connected to each other and the respective solid oxide fuel cells C are connected in parallel in the fuel cell unit C1 in each of the embodiments of the solid oxide fuel cell power generator according to the invention, for example, the first extended portion 41 and the second extended portion 61 may be connected in series also in the fuel cell unit Cl. In this case, it is preferable that the first extended portion 41 and the second extended portion 61 should be extended in the same direction in such a manner that they do not overlap with each other in the planar direction in order to simplify the wiring.

While the mixed fuel gas is burned by the combustion apparatus 13 disposed below the fuel cell unit C1 and each of the solid oxide fuel cells C is thus heated in each of the embodiments, moreover, it is possible to use a well-known heating method other than the combustion apparatus 13 if the solid oxide fuel cell C can be heated to a predetermined temperature so as to be driven. For example, it is possible to use an electric furnace, a gas burner or an electric heater, for example.

Although the fuel cell unit C1 is accommodated in the container 11 in each of the embodiments, furthermore, the fuel cell unit Cl does not need to be accommodated in the container if it is disposed in a mixed fuel gas atmosphere.

While the separators 14a and 14b are disposed between the fuel cell stacks in the fourth embodiment, moreover, the separators 14a and 14b may be removed.

All of the portions according to only one of the embodiments can be properly utilized mutually with the other embodiments.

The present invention having been described with reference to the foregoing embodiments should not be limited to the disclosed embodiments and modifications, but may be implemented in many ways without departing from the spirit of the invention.

What is claimed is:

1. A solid oxide fuel cell power generator comprising a plurality of solid oxide fuel cells, each having a cathode electrode layer and an anode electrode layer formed on both sides of a solid electrolytic substrate thereof, wherein
first one of said plurality of solid oxide fuel cells and second one of said plurality of solid oxide fuel cells, being stacked adjacently thereto, are disposed in such a manner that an anode electrode layer of said first one of said plurality of solid oxide fuel cells and another anode electrode layer of said second one of said plurality of solid oxide fuel cells are opposed to each other, wherein
a first electric conductor, having a gas permeability and functioning as a collector, is interposed between said opposed anode electrode layers in contact thereto, said first electric conductor including a first extended portion which is extended beyond each of the anode electrode layers.

2. The solid oxide fuel cell power generator according to claim 1, wherein a cathode electrode layer of said second one of said plurality of solid oxide fuel cells and a cathode electrode layer of third one of said plurality of solid oxide fuel cells, being stacked adjacently thereto, are opposed to each other, wherein a second electric conductor having a gas permeability and functioning as a collector is interposed between the opposed cathode electrode layers in contact thereto, said second electric conductor including a second extended portion which is extended beyond each of the cathode electrode layers.

3. The solid oxide fuel cell power generator according to claim 2, wherein the first extended portion and the second extended portion are disposed to be laterally offset in opposite directions to each other.

4. The solid oxide fuel cell power generator according to claim 2, wherein at least any one of the first electric conductor and the second electric conductor is formed in a concavo-convex shape.

5. The solid oxide fuel cell power generator according to claim 2, wherein at least any one of the first electric conductor and the second electric conductor is formed in a corrugate shape.

6. The solid oxide fuel cell power generator according to claim 2, wherein said solid oxide fuel cell power generator is further comprised of a third electric conductor which is made of a gas permeability material and is interposed between the first electric conductor and the anode electrode layer and between the second electric conductor and the cathode electrode layer, respectively.

7. The solid oxide fuel cell power generator according to claim 6, wherein at least any one of the first electric conductor, the second electric conductor and the third electric conductor is formed by a metallic mesh or a porous body.

8. The solid oxide fuel cell power generator according to claim 7, wherein the metallic mesh disposed between the opposed anode electrode layers is formed of nickel or an alloy of the nickel and copper.

9. The solid oxide fuel cell power generator according to claim 2, wherein said solid oxide fuel cell power generator is further comprised of a first connector which connects the first extended portion and another first extended portion thereof.

10. The solid oxide fuel cell power generator according to claim 2, wherein said solid oxide fuel cell power generator is further comprised of a second connector which connects the second extended portion and another second extended portion thereof

11. The solid oxide fuel cell power generator according to claim 2, wherein said solid oxide fuel cell power generator is further comprised:
a first connector connecting the first extended portion and another first extended portion, and
a second connector connecting the second extended portion and another second extended portion, further wherein
a fuel cell stack of the solid oxide fuel cell power generator is interposed between a pair of support plates, and each of the support plates is a metal plate having a surface covered with inorganic oxide.

12. The solid oxide fuel cell power generating system including a plurality of sub-power generators, wherein
each of said plurality of sub-power generators is further comprised of a plurality of solid oxide fuel cells, each having a cathode electrode layer and an anode electrode layer formed on both sides of a solid electrolytic substrate thereof, wherein
first one of said plurality of solid oxide fuel cells and second one of said plurality of solid oxide fuel cells, being stacked adjacently thereto, are disposed in such a manner that an anode electrode layer of said first one of said plurality of solid oxide fuel cells and another anode electrode layer of said second one of said plurality of solid oxide fuel cells are opposed to each other, wherein
a first electric conductor, having a gas permeability and functioning as a collector, is interposed between said opposed anode electrode layers in contact thereto, said first electric conductor including a first extended portion which is extended beyond each of the anode electrode layers, wherein
a cathode electrode layer of said second one of said plurality of solid oxide fuel cells and a cathode electrode layer of third one of said plurality of solid oxide fuel cells, being stacked adjacently thereto, are opposed to each other, wherein a second electric conductor having a gas permeability and functioning as a collector is interposed between the opposed cathode electrode layers in contact thereto, said second electric conductor including a second extended portion which is extended beyond each of the cathode electrode layers, wherein
the first extended portion and another first extended portion are connected by a first connector, while the second extended portion and another second extended portion are connected by a second connector, wherein
one of said plurality of sub-power generators and another one of said plurality of sub-power generators are electrically connected in parallel or in series via the first connectors and the second connectors, respectively.

13. The solid oxide fuel cell power generator system according to claim 12, wherein said plurality of sub-power generators are electrically separated from each other by a plurality of separators being interposed therebetween.
